(19) United States
(12) Patent Application Publication
(10) Pub. No.: US 2021/0034472 A1
(43) Pub. Date: Feb. 4, 2021

(54) METHOD AND SYSTEM FOR ANY-POINT-IN-TIME RECOVERY WITHIN A CONTINUOUS DATA PROTECTION SOFTWARE-DEFINED STORAGE

(71) Applicant: Dell Products L.P., Hopkinton, MA (US)

(72) Inventors: Dharmesh M. Patel, Round Rock, TX (US); Rizwan Ali, Cedar Park, TX (US); Ravikanth Chaganti, Bangalore (IN)

(21) Appl. No.: 16/528,612

(22) Filed: Jul. 31, 2019

(51) Int. Cl. G06F 11/14; G06F 16/215

(52) U.S. Cl. CPC G06F 11/1453; G06F 2201/84; G06F 16/215

(57) ABSTRACT

A method for managing data includes obtaining data from a host, applying an erasure coding procedure to the data to obtain a plurality of data chunks and at least one parity chunk, deduplicating the plurality of data chunks to obtain a plurality of deduplicated data chunks, generating storage metadata associated with the plurality of deduplicated data chunks and the at least one parity chunk, generating an object entry associated with the plurality of deduplicated data chunks and the at least one parity chunk, storing the storage metadata and the object entry in an accelerator pool, storing, across a plurality of fault domains, the plurality of deduplicated data chunks and the at least one parity chunk, and initiating metadata distribution on the storage metadata and the object entry across the plurality of fault domains.

### BACKGROUND

Computing devices may include any number of internal components such as processors, memory, and persistent storage. Each of the internal components of a computing device may be used to generate data. The process of generating, storing, and backing-up data may utilize computing resources of the computing devices such as processing and storage. The utilization of the aforementioned computing resources to generate backups may impact the overall performance of the computing resources.

### SUMMARY

In general, in one aspect, the invention relates to a method for managing data. The method includes obtaining data from a host, applying an erasure coding procedure to the data to obtain a plurality of data chunks and at least one parity chunk, deduplicating the plurality of data chunks to obtain a plurality of deduplicated data chunks, generating storage metadata associated with the plurality of deduplicated data chunks and the at least one parity chunk, generating an object entry associated with the plurality of deduplicated data chunks and the at least one parity chunk, storing the storage metadata and the object entry in an accelerator pool, storing, across a plurality of fault domains, the plurality of deduplicated data chunks and the at least one parity chunk, and initiating metadata distribution on the storage metadata and the object entry across the plurality of fault domains.

In general, in one aspect, the invention relates to a non-transitory computer readable medium which includes computer readable program code, which when executed by a computer processor enables the computer processor to perform a method for managing data. The method includes obtaining data from a host, applying an erasure coding procedure to the data to obtain a plurality of data chunks and at least one parity chunk, deduplicating the plurality of data chunks to obtain a plurality of deduplicated data chunks, generating storage metadata associated with the plurality of deduplicated data chunks and the at least one parity chunk, generating an object entry associated with the plurality of deduplicated data chunks and the at least one parity chunk, storing the storage metadata and the object entry in an accelerator pool, storing, across a plurality of fault domains, the plurality of deduplicated data chunks and the at least one parity chunk, and initiating metadata distribution on the storage metadata and the object entry across the plurality of fault domains.

In general, in one aspect, the invention relates to a data cluster that includes a host, an accelerator pool that includes a plurality of data nodes, wherein a data node of the plurality of data nodes includes a processor and memory that includes instructions, which when executed by the processor perform a method. The method includes obtaining data from the host, applying an erasure coding procedure to the data to obtain a plurality of data chunks and at least one parity chunk, deduplicating the plurality of data chunks to obtain a plurality of deduplicated data chunks, generating storage metadata associated with the plurality of deduplicated data chunks and the at least one parity chunk, generating an object entry associated with the plurality of deduplicated data chunks and the at least one parity chunk, storing the storage metadata and the object entry in the accelerator pool, storing, across a plurality of fault domains, the plurality of deduplicated data chunks and the at least one parity chunk, and initiating metadata distribution on the storage metadata and the object entry across the plurality of fault domains.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of a data cluster in accordance with one or more embodiments of the invention.

FIG. 1C shows a diagram of a data node in accordance with one or more embodiments of the invention.

FIG. 1D shows a diagram of persistent storage in accordance with one or more embodiments of the invention.

FIG. 1E shows a diagram of a non-accelerator pool in accordance with one or more embodiments of the invention.

FIG. 2A shows a diagram of storage metadata in accordance with one or more embodiments of the invention.

FIG. 2B shows a diagram of object metadata in accordance with one or more embodiments of the invention.

FIG. 3A shows a flowchart for storing data in a data cluster in accordance with one or more embodiments of the invention.

FIG. 3B shows a flowchart for performing an object replay in accordance with one or more embodiments of the invention.

FIGS. 4A-4C show an example in accordance with one or more embodiments of the invention.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to a method and system for storing data and metadata in a data cluster. Embodiments of the invention may utilize a data processor, operating in an accelerator pool, which applies an erasure coding procedure on data obtained from a host to divide the data into data chunks and to generate parity chunks using the data chunks. The data processor may then perform deduplication on the data chunks to generate deduplicated data that includes deduplicated data chunks. The deduplicated data chunks and the parity chunks are subsequently distributed to nodes in the data cluster in accordance with an erasure coding procedure.

In one or more embodiments of the invention, the accelerator pool stores storage metadata that specifies the nodes in which each data chunk and parity chunk is stored and object metadata that specifies an object associated with each data chunk. The storage metadata and object metadata may also be distributed to nodes in the non-accelerator pool. In this manner, if the storage metadata or object metadata stored in the accelerator pool becomes unavailable, the storage metadata may be reconstructed using the storage metadata and object metadata stored in the non-accelerator pool.

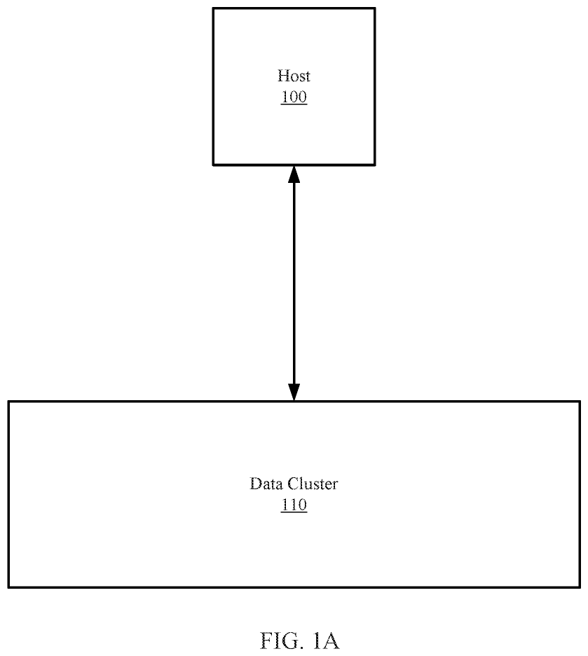

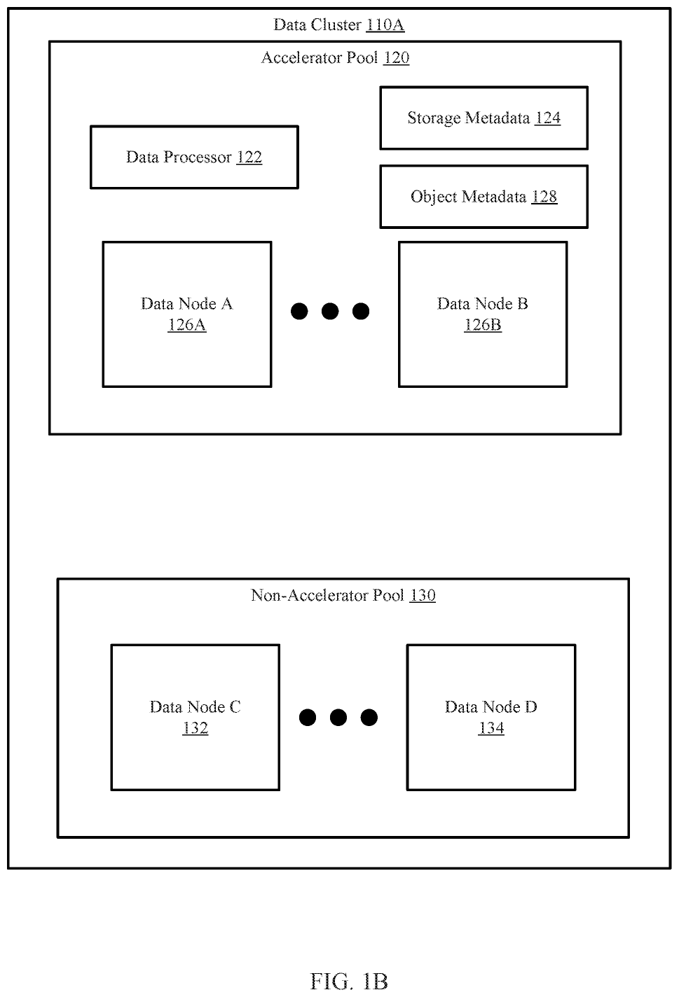

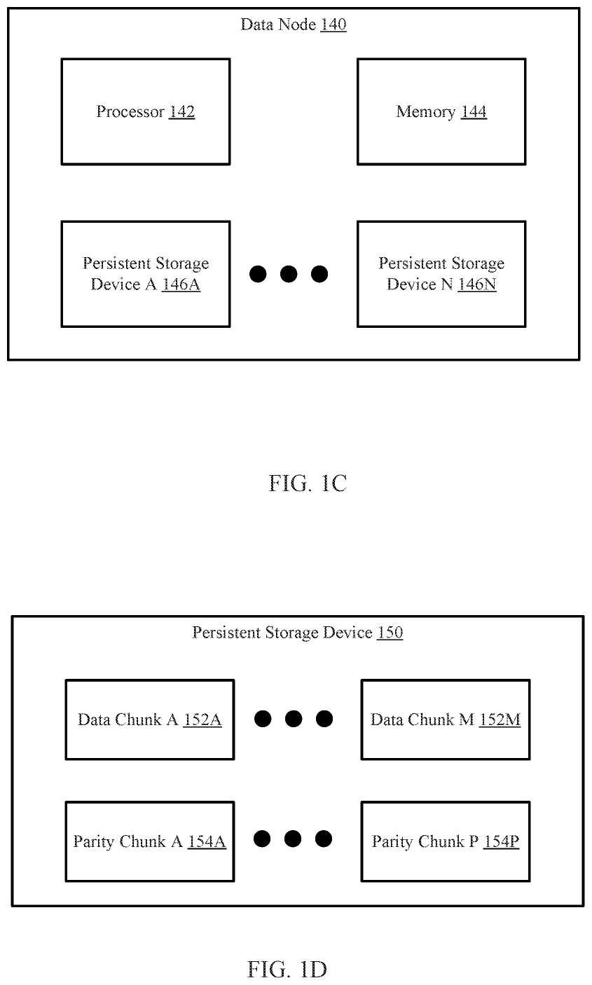

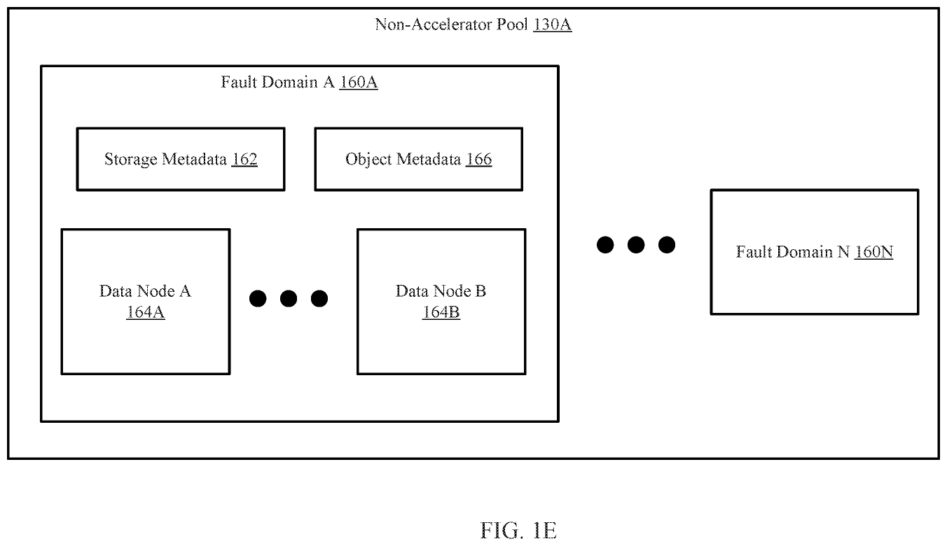

FIG. 1A shows an example system in accordance with one or more embodiments of the invention. The system includes a host (100) and a data cluster (110). The host (100) is operably connected to the data cluster (110) via any combination of wired and/or wireless connections.

In one or more embodiments of the invention, the host (100) utilizes the data cluster (110) to store data. The data stored may be backups of databases, files, applications, and/or other types of data without departing from the invention.

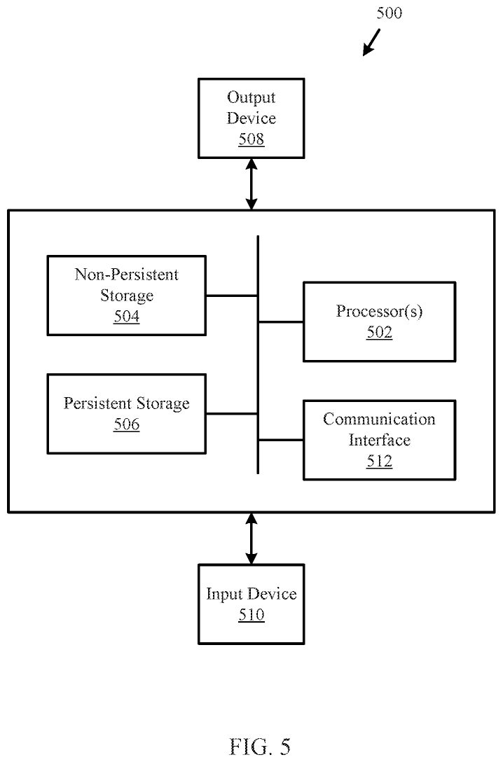

In one or more embodiments of the invention, the host (100) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the host (100) described throughout this application.

In one or more embodiments of the invention, the host (100) is implemented as a logical device. The logical device may utilize the computing resources of any number of computing devices and thereby provide the functionality of the host (100) described throughout this application.

In one or more embodiments of the invention, the data cluster (110) stores data, metadata, and/or backups of data generated by the host (100). The data and/or backups may be deduplicated versions of data obtained from the host. The data cluster may, via an erasure coding procedure, store portions of the deduplicated data across nodes operating in the data cluster (110).

As used herein, deduplication refers to methods of storing only portions of files (also referred to as file segments or segments) that are not already stored in persistent storage. For example, when multiple versions of a large file, having only minimal differences between each of the versions, are stored without deduplication, storing each version will require approximately the same amount of storage space of a persistent storage. In contrast, when the multiple versions of the large file are stored with deduplication, only the first version of the multiple versions stored will require a substantial amount of storage. Once the first version is stored in the persistent storage, the subsequent versions of the large file subsequently stored will be de-duplicated before being stored in the persistent storage resulting in much less storage space of the persistent storage being required to store the subsequently stored versions when compared to the amount of storage space of the persistent storage required to store the first stored version.

Continuing with the discussion of FIG. 1A, the data cluster (110) may include nodes that each store any number of portions of data. The portions of data may be obtained by other nodes or obtained from the host (100). For additional details regarding the data cluster (110), see, e.g., FIG. 1B.

FIG. 1B shows a diagram of a data cluster (110A) in accordance with one or more embodiments of the invention. The data cluster (110A) may be an embodiment of the data cluster (110, FIG. 1A) discussed above. The data cluster (110A) may include an accelerator pool (120) and a non-accelerator pool (130). The accelerator pool (120) may include a data processor (122), storage metadata (124), object metadata (128) and any number of data nodes (126A, 126B). Similarly, the non-accelerator pool (130) includes any number of data nodes (132, 134). The components of the data cluster (110A) may be operably connected via any combination of wired and/or wireless connections. Each of the aforementioned components is discussed below.

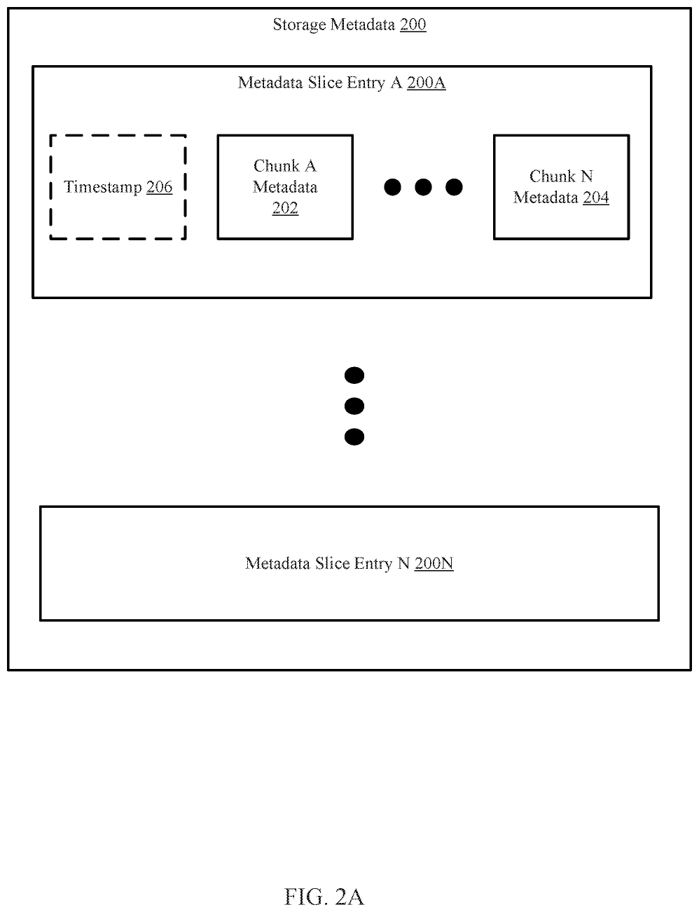

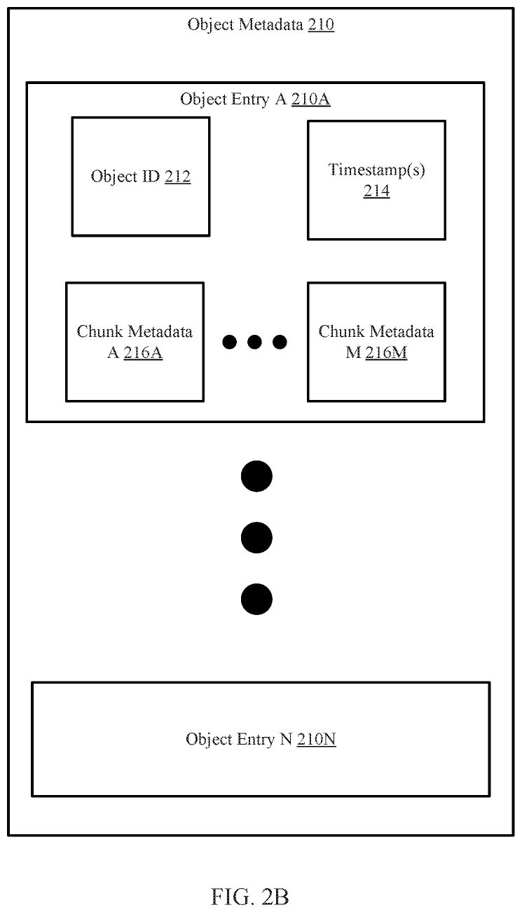

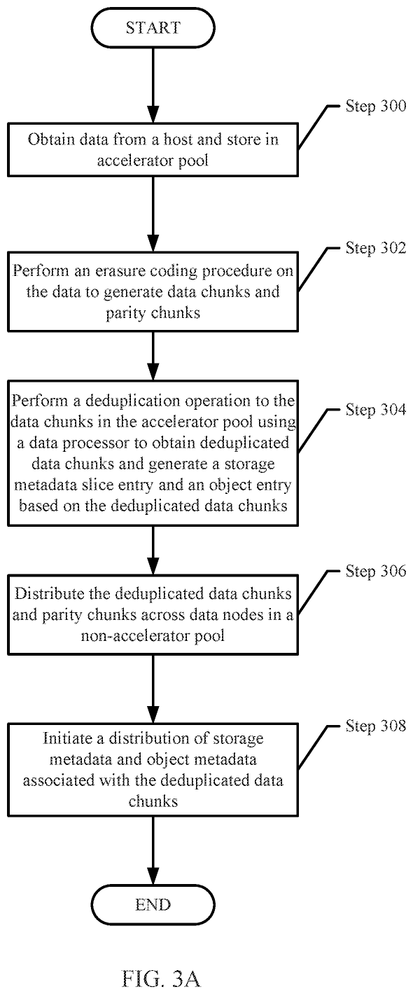

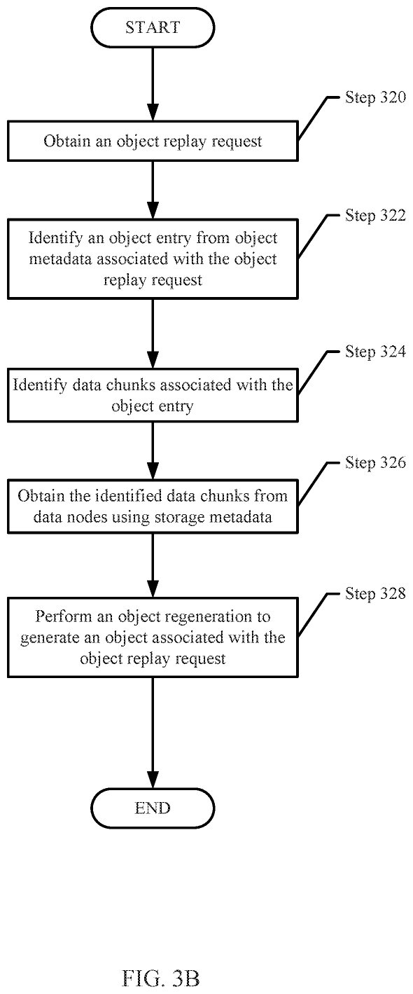

In one or more embodiments of the invention, the data processor (122) is a device that includes functionality to perform erasure coding and/deduplication on data obtained from a host (e.g., 100, FIG. 1A). The data processor (122) may generate, utilize, and update storage metadata (124) (as described in FIG. 2A) as part of its deduplication functionality. In one or more embodiments of the invention, the storage metadata (124) is a data structure that stores unique identifiers of portions data stored in the data cluster (110A). The unique identifiers stored in the storage metadata (124) may be used to determine whether a data chunk of the obtained data is already present elsewhere in the accelerator pool (120) or the non-accelerator pool (130). The data processor (122) may use the storage information to perform the deduplication and generate deduplicated data. The data processor (122) may perform the deduplication and erasure coding procedure via the method illustrated in FIG. 3A.

In one or more embodiments of the invention, the storage metadata (124) is stored in a data node (126A, 126B) of the accelerator pool (120). A copy of the storage metadata (124) may be distributed to one or more data nodes (132, 134) of the non-accelerator pool (130). In this manner, if the storage metadata (124) stored in the accelerator pool (120) experiences a failure (e.g., it becomes unavailable, corrupted, etc.), the storage metadata (124) may be reconstructed using the copies of storage metadata stored in the non-accelerator pool (130). For additional detail regarding the distribution on storage metadata, see e.g., FIG. 3A.

In one or more embodiments of the invention, the data processor (122) updates object metadata (128) after storing data chunks (which may be deduplicated data chunks) and parity chunks. In one or more embodiments of the invention, the object metadata is a data structure, stored in a computing device (e.g., a data node (126A, 126B)) of the accelerator pool (120), which includes object information about the data stored in the data cluster (110A). An object may be, for example, a file, a set of files, a portion of a file, a backup of any combination thereof, and/or any other type of data without departing from the invention. For additional details regarding the object metadata, see, e.g., FIG. 2B.

In one or more of embodiments of the invention, the data processor (122) is implemented as computer instructions, e.g., computer code, stored on a persistent storage that when executed by a processor of a data node (e.g., 126A, 126B) of the accelerator pool (120) cause the data node to provide the aforementioned functionality of the data processor (122) described throughout this application and/or all, or a portion thereof, of the method illustrated in FIG. 3A.

In one or more embodiments of the invention, the data processor (122) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data processor (122) described throughout this application and/or all, or a portion thereof, of the method illustrated in FIGS. 3A-3B.

In one or more embodiments of the invention, the data processor (122) is implemented as a logical device. The logical device may utilize the computing resources of any number of computing devices and thereby provide the functionality of the data processor (122) described throughout this application and/or all, or a portion thereof, of the method illustrated in FIG. 3A.

Continuing with the discussion of FIG. 1B, different data nodes in the cluster may include different quantities and/or types of computing resources, e.g., processors providing processing resources, memory providing memory resources, storages providing storage resources, communicators providing communications resources. Thus, the system may include a heterogeneous population of nodes.

The heterogeneous population of nodes may be logically divided into: (i) an accelerator pool (120) including nodes that have more computing resources, e.g., high performance nodes (126A, 126B), than other nodes and (ii) a non-accelerator pool (130) including nodes that have fewer computing resources, e.g., low performance nodes (132, 134) than the nodes in the accelerator pool (120). For example, nodes of the accelerator pool (120) may include enterprise-class solid state storage resources that provide very high storage bandwidth, low latency, and high input-outputs per second (TOPS). In contrast, the nodes of the non-accelerator pool (130) may include hard disk drives that provide lower storage performance. While illustrated in FIG. 1B as being divided into two groups, the nodes may be divided into any number of groupings based on the relative performance level of each node without departing from the invention.

In one or more embodiments of the invention, the data nodes (126A, 126B, 132, 134) store data chunks and parity chunks along with storage metadata and object metadata (as described below). The data nodes (126A, 126B, 132, 134) may include persistent storage that may be used to store the data chunks, parity chunks and storage metadata. The generation of the data chunks and parity chunks as well as the storage metadata is described below with respect to FIG. 3A. For additional details regarding the data nodes (126A, 126B, 132, 134), see, e.g., FIG. 1C.

In one or more embodiments of the invention, the non-accelerator pool (130) includes any number of fault domains. In one or more embodiments of the invention, a fault domain is a logical grouping of nodes (e.g., data nodes) that, when one node of the logical grouping of nodes goes offline and/or otherwise becomes inaccessible, the other nodes in the same logical grouping of nodes are directly affected. However, nodes in a different fault domain may be unaffected. For additional details regarding fault domains, see, e.g. FIG. 1E.

In one or more embodiments of the invention, each data node (126A, 126B, 132, 134) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data node (126A, 126B, 132, 134) described throughout this application and/or all, or a portion thereof, of the method illustrated in FIGS. 3A-3B.

In one or more embodiments of the invention, each of the data nodes (126A, 126B, 132, 134) is implemented as a logical device. The logical device may utilize the computing resources of any number of computing devices and thereby provide the functionality of the data nodes (126A, 126B, 132, 134) described throughout this application and/or all, or a portion thereof, of the method illustrated in FIGS. 3A-3B. For additional details regarding the data nodes (126A, 126B, 132, 134), see, e.g., FIG. 1C.

FIG. 1C shows a diagram of a data node (140) in accordance with one or more embodiments of the invention. The data node (140) may be an embodiment of a data node (126A, 126B, 132, 134, FIG. 1B) discussed above. Each data node may be equipped with a processor (142), memory (144), and one or more persistent storage devices (146A, 146N). Each component of the data node (140) may be operatively connected to each other via wired and/or wireless connections. The data node (140) may have additional, fewer, and/or different components without departing from the invention. Each of the illustrated components of the data node (140) is discussed below.

In one or more embodiments of the invention, the processor (142) is a component that processes data and/or processes requests. The processor (142) may be, for example, a central processing unit (CPU). The processor may process object rebuild request and/or requests to rebuild data and/or metadata using data stored in memory (144) and/or the persistent storage devices (146A, 146N). The processor (142) may process other requests without departing from the invention.

In one or more embodiments of the invention, the data node includes memory (144) which stores data that is more accessible to the processor (142) than the persistent storage devices (146A, 146N). The memory (144) may be volatile storage. Volatile storage may be storage that stores data that is lost when the storage loses power. The memory may be, for example, Random Access Memory (RAM). In one or more embodiments of the invention, a copy of the storage metadata discussed in FIG. 1B is stored in the memory (144) of the data node (140).

In one or more embodiments of the invention, the persistent storage devices (146A, 146N) store data. The data may be data chunks and/or parity chunks. In addition, the data may also include storage metadata. The persistent storage devices (146A, 146N) may be non-volatile storage. In other words, the data stored in the persistent storage devices (146A, 146N) is not lost or removed when the persistent storage devices (146A, 146N) lose power. Each of the persistent storage devices (146A, 146N) may be, for example, solid state drives, hard disk drives, and/or tape drives. The persistent storage devices may include other types of non-volatile or non-transitory storage mediums without departing from the invention. For additional details regarding the persistent storage devices, see, e.g., FIG. 1D.

FIG. 1D shows a diagram of a persistent storage device. The persistent storage device (150) may be an embodiment of a persistent storage device (146A, 146N) discussed above. As discussed above, the persistent storage device (150) stores data. The data may be data chunks (152A, 152M) and parity chunks (154A, 154P). Though not shown in FIG. 1D, the data may also include storage metadata

In one or more embodiments of the invention, a data chunk (152A, 152M) is a data structure that includes a portion of data that was obtained from a host. The data chunks (152A, 152M) may be deduplicated by a data processor and obtained by the data node (140) from the data processor. Each of the data chunks (152A, 152M) may be used by the data node (140) (or another data node) to reconstruct another data chunk or a parity chunk based on an erasure coding algorithm that was applied to the other data chunk or parity chunk.

In one or more embodiments of the invention, a parity chunk (154A, 154P) is a data structure that includes a parity value generated using an erasure coding algorithm. The parity value may be generated by applying the erasure coding algorithm to one or more data chunks stored in the data node (140) or other data nodes. Each of the parity chunks (154A, 154P) may be used by the data node (140) (or another data node) to reconstruct another parity chunk or a data chunk based on an erasure coding algorithm that was applied to the other parity chunk or data chunk.

FIG. 1E shows a diagram of a non-accelerator pool in accordance with one or more embodiments of the invention. The non-accelerator pool (130A) is an embodiment of the non-accelerator pool (130, FIG. 1B) discussed above. The non-accelerator pool (130A) may include any number of fault domains (160A, 160N).

As discussed above, a fault domain (160A, 160N) is a logical grouping of data nodes (164A, 164B) that, when one data node of the logical grouping of data nodes goes offline and/or otherwise becomes inaccessible, the other nodes in the logical grouping of nodes are directly affected. The effect of the node going offline to the other nodes may include the other nodes also going offline and/or otherwise inaccessible. The non-accelerator pool (130) may include multiple fault domains. In this manner, the events of one fault domain in the non-accelerator pool (130A) may have no effect to other fault domains in the non-accelerator pool (130A).

For example, two data nodes may be in a first fault domain (e.g., 160A). If one of these data nodes in the first fault domain (160A) experiences an unexpected shutdown, other nodes in the first fault domain may be affected. In contrast, another data node in a second fault domain may not be affected by the unexpected shutdown of a data node in the first fault domain. In one or more embodiments of the invention, the unexpected shutdown of one fault domain does not affect the nodes of other fault domains. In this manner, data may be replicated and stored across multiple fault domains to allow high availability of the data.

As discussed above, the data chunks and parity chunks (e.g., generated using the erasure coding described in FIG. 3A) may be stored in different fault domains (160A, 160N). Storing the data chunks and parity chunks in multiple fault domains may be for recovery purposes. In the event that one or more fault domains storing data chunks or parity chunks become inaccessible, the data chunks and/or parity chunks stored in the remaining fault domains may be used to recreate the inaccessible data. In one embodiment of the invention, as part of (or in addition to) the chunk metadata, the storage metadata (162) tracks the related data chunks and parity chunks (i.e., which data chunks and which parity chunks are associated with a metadata slice). This information may be used to aid in any recover operation that is required to be performed on the data stored in the data cluster.

In one or more embodiments of the invention, each fault domain (160A, 160N) stores a copy of storage metadata (162) and a copy of object metadata (166) obtained from an accelerator pool and/or from another fault domain (160A, 160N) distributing a copy of the storage metadata. The copy of storage metadata (162) and the copy of the object metadata (166) in a fault domain (e.g., 160A) may each be stored in one or more data nodes (164A, 164B) of the fault domain. The copy of storage metadata (162) and the copy of object metadata (166) may each be stored in any other computing device associated with the fault domain (160A) without departing from the invention.

FIG. 2A shows a diagram of storage metadata in accordance with one or more embodiments of the invention. The storage metadata (200) may be an embodiment of the storage metadata (124, FIG. 1B; 162, FIG. 1E) discussed above. As discussed above, the storage metadata (200) stores information about data chunks or parity chunks (collectively, chunks). The storage information may include one or more metadata slice entries (200A, 200N). Each metadata slice entry (200A, 200N) may include chunk metadata (202, 204) and a timestamp (206). Each of the aforementioned portions of the storage metadata (200) is discussed below.

In one or more embodiments of the invention, a metadata slice entry (200A, 200N) is an entry that specifies metadata associated with chunks of a data and parity generated using an erasure coding procedure. The metadata slice entry (200A, 200N) includes chunk metadata (202, 204). Each chunk of a chunk metadata (202, 204) may correspond to metadata for a data chunk or a parity chunk. Each chunk metadata (202, 204) may include information about a chunk such as, for example, a unique identifier (e.g., a fingerprint) and a storage location of the chunk, e.g., the non-accelerator pool. The unique identifier of a chunk may be generated using the chunk (e.g., calculated using the data of the chunk).

In one or more embodiments of the invention, the timestamp (206) specifies a point in time in which the metadata slice was generated and/or stored in the non-accelerator pool. The timestamp (206) may be used to associate the metadata slice to the point in time. In one or more embodiments of the invention, the timestamp (206) is optionally included in the metadata slice entries (200A, 200N).

FIG. 2B shows a diagram of object metadata in accordance with one or more embodiments of the invention. The object metadata (210) may be an embodiment of the storage metadata (128, FIG. 1B; 166, FIG. 1E) discussed above. As discussed above, the object metadata (210) stores information about objects. The object metadata (210) may include one or more object entries (210A, 210N). Each object entry (210A, 210N) may include an object ID (212), chunk metadata (216A, 216M) and a timestamp (214). Each of the aforementioned portions of the object metadata (210) is discussed below.

In one or more embodiments of the invention, the object ID (212) is an identifier that specifies an object associated with the object entry (210A, 210N). The object ID (212) may be, for example, a string of numbers, letters, symbols, or any combination thereof that uniquely identifies the object.

In one or more embodiments of the invention, the timestamp (214) specifies a point in time that corresponds to a state of the object as specified by a set of chunk metadata. The timestamp (214) may be used to replay the object to a point in time. In one or more embodiments of the invention, the object is replayed to a point in time when the data associated with the object that was part of the object at the point in time is reconstructed to generate the object at the point in time. Said another way, the content of each object may vary over time and each time the object is modified a corresponding object entry is created where the object entry specifies chunk metadata for the chunks that make up the object at that point in time.

For example, at a first point in time, the object may include a first set of data, of which there is a first chunk and a second chunk. At a second point in time, the object may include a second set of data, of which there is a first chunk and a third chunk. The third chunk may be a modified version of the second chunk. The object may be replayed to the first point in time by obtaining the first chunk and the second chunk. The object may be replayed to the second point in time by obtaining the first chunk and the third chunk. For each point in time, there may be an object entry that specifies the object, the point in time, and each chunk used to replay the object.

In one or more embodiments of the invention, the chunk metadata (216A, 216M) each corresponds to a data chunk or parity chunk associated with the object at the point in time specified by the timestamp (214). The chunk metadata may include information about the data chunk or parity chunk such as, for example, a unique identifier (e.g., a fingerprint). The unique identifier may be, for example, a string of numbers, letters, symbols, or any combination thereof that uniquely identifies the chunk.

In one or more embodiments of the invention, an object entry (210A) is associated with more than one timestamp (214). In such embodiments, each chunk metadata (216A, 216M) may specify multiple chunks associated with a point in time. For example, after every iteration of an object (i.e., an object is associated with a new point in time), an object entry (210A, 210N) is updated with new chunk metadata (216A, 216M) that specifies the chunks of that iteration. In this manner, each object is associated with one object entry (210A, 210N) and each chunk metadata (202, 204) is associated with multiple chunks of an object at a point in time.

The object metadata (210) may be organized using other schemes without departing from the invention.

FIG. 3A shows a flowchart for storing data in a data cluster in accordance with one or more embodiments of the invention. The method shown in FIG. 3A may be performed by, for example, a data processor (122, FIG. 1B). Other components of the system illustrated in FIG. 1B may perform the method of FIG. 3A without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 300, data is obtained from a host. The data may be, for example, an object. The object may be a file, a file segment, a collection of files, or any other type of data without departing from the invention.

In step 302, an erasure coding procedure is performed on the data to generate data chunks and parity chunks. In one or more embodiments of the invention, the erasure coding procedure includes dividing the obtained data into portions, referred to as data chunks. Each data chunk may include any number of data segments associated with the obtained data. The individual data chunks may then be combined (or otherwise grouped) into slices (also referred to as Redundant Array of Independent Disks (RAID) slices). One or more parity values are then calculated for each of the aforementioned slices. The number of parity values may vary based on the erasure coding algorithm that is being used as part of the erasure coding procedure. Non-limiting examples of erasure coding algorithms are RAID-3, RAID-4, RAID-5, and RAID-6. Other erasing coding algorithms may be used without departing from the invention.

Continuing with the above discussion, if the erasing code procedure is implementing RAID-3, then a single parity value is calculated. The resulting parity value is then stored in a parity chunk. If erasure coding procedure algorithm requires multiple parity values to be calculated, then the multiple parity values are calculated with each parity value being stored in a separate data chunk.

As discussed above, the data chunks are used to generate parity chunks in accordance with the erasure coding procedure. More specifically, the parity chunks may be generated by applying a predetermined function (e.g., P Parity function, Q Parity Function), operation, or calculation to at least one of the data chunks. Depending on the erasure coding procedure used, the parity chunks may include, but are not limited to, P parity values and/or Q parity values.

In one embodiment of the invention, the P parity value is a Reed-Solomon syndrome and, as such, the P Parity function may correspond to any function that can generate a Reed-Solomon syndrome. In one embodiment of the invention, the P parity function is an XOR function.

In one embodiment of the invention, the Q parity value is a Reed-Solomon syndrome and, as such, the Q Parity function may correspond to any function that can generate a Reed-Solomon syndrome. In one embodiment of the invention, a Q parity value is a Reed-Solomon code. In one embodiment of the invention, Q=g₀·D₀+g₁·D₁+g₂D₂+ . . . +gₙ₋₁·gₙ₋₁·Dₙ₋₁, where Q corresponds to the Q parity, g is a generator of the field, and the value of D corresponds to the data in the data chunks.

In one or more embodiments of the invention, the number of data chunks and parity chunks generated is determined by the erasure coding procedure, which may be specified by the host, by the data cluster, and/or by another entity.

In step 304, deduplication is performed on the data chunks to obtain deduplicated data chunks. Additionally, a storage metadata slice entry is generated based on the deduplication data chunks and the parity chunks. Further, an object slice entry is generated based data chunks (i.e., non-deduplicated data chunks) and the parity chunks with a timestamp.

In one or more embodiments of the invention, the deduplication is performed in the accelerator pool by identifying the data chunks of the obtained data and assigning a fingerprint to each data chunk. A fingerprint is a unique identifier that may be stored in metadata of the data chunk. The data processor performing the deduplication may generate a fingerprint for a data chunk and identify whether the fingerprint matches an existing fingerprint stored in storage metadata stored in the accelerator pool. If the fingerprint matches an existing fingerprint, the data chunk may be deleted, as it is already stored in the data cluster. If the fingerprint does not match any existing fingerprints, the data chunk may be stored as a deduplicated data chunk. Additionally, the fingerprint of each deduplicated data chunk is stored in a storage metadata slice entry of the storage metadata. A fingerprint (or other unique identifier) of each parity chunk is also generated and stored in the storage metadata slice entry.

In one or more embodiments of the invention, the deduplicated data chunks collectively make up the deduplicated data. In one or more embodiments of the invention, the deduplicated data chunks are the data chunks that were not deleted during deduplication.

In step 306, the deduplicated data chunks and parity chunk(s) are stored across data nodes in different fault domains in a non-accelerator pool. As discussed above, the deduplicated data chunks and the parity chunk(s) are stored in a manner that minimizes reads and writes from the non-accelerator pool. In one embodiment of the invention, this minimization is achieved by storing data chunks and parity chunks, which are collective referred to as a data slice (or slice), in the same manner as a prior version of the data slice. The data processor may use, as appropriate, storage metadata for the previously stored data chunks and parity chunks to determine where to store the data chunks and parity chunks in step 306.

More specifically, in one embodiment of the invention, if the deduplicated data chunks and parity chunks are the first version of a data slice (as opposed to a modification to an existing/previously stored data slice), then the deduplicated data chunks and parity chunks may be stored across the data nodes (each in a different fault domain) in the non-accelerator pool. The location in which the data chunk or parity chunk is stored is tracked using the storage metadata. The scenario does not require the data processor to use location information for previously stored data chunks and parity chunks.

However, if the deduplicated data chunks and parity chunks are the second version of a slice (e.g., a modification to a previously stored slice), then the deduplicated data chunks and parity chunks are stored across the nodes (each in a different fault domain) in the non-accelerator pool using prior stored location information. The information about the location in which the data chunk or parity chunk for the second version of the slice is stored in the storage metadata.

For example, consider a scenario in which the first version of the slice includes three data chunks (D1, D2, D3) and one parity chunk (P1) that were stored as follows: Data Node 1 stores D1, Data Node 2 stores D2, Data Node 3 stores D3, and Data Node 4 stores P1. Further, in this example, a second version of the slice is received that includes three data chunks (D1, D2′, D3) and one newly calculated parity chunk (P1′). After deduplication only D2′ and P r need to be stored. Based on the prior storage locations (also referred to as locations) of the data chunks (D1, D2, and D3) and parity chunks (P1) for the first version of the slice, D2′ is stored on Node 2 and P r is stored on Node 4. By storing the D2′ on Node 2 and P r on Node 4 the data chunks and parity chunks associated with the second slice satisfy the condition that all data chunks and parity chunks for the second version of the slice are being stored in separate fault domains. If the location information was not taken into account, then the entire slice (i.e., D1, D2′, D3, and P1′) would need to be stored in order to guarantee that the requirement that all data chunks and parity chunks for the second version of the slice are being stored in separate fault domains is satisfied.

In one or more embodiments of the invention, if the data node that obtains the deduplicated data chunk, which is a modified version of a prior stored deduplicated data chunk, then the data node may: (i) store the modified version of the deduplicated data chunk (i.e., the data node would include two versions of the data chunk) or (ii) store the modified version of the deduplicated data chunk and delete the prior version of the deduplicated data chunk.

In one embodiment of the invention, the data processor includes functionality to determine whether a given data chunk is a modified version of a previously stored data chunk. Said another way, after the data is received from a host divided into data chunks and grouped into slices, the data processor includes functionality to determine whether a slice is a modified version of a prior stored slice. The data processor may use the fingerprints of the data chunks within the slice to determine whether the slice is a modified version of a prior stored slice. Other methods for determining whether a data chunk is a modified version of a prior stored data chunk and/or whether a slice is a modified version of a prior slice without departing from the invention.

In step 308, a distribution of storage metadata and object metadata is initiated. In one or more embodiments of the invention, the storage metadata and the object metadata are distributed by generating a copy of the storage metadata that includes the storage metadata slice entry generated in step 304 and a copy of object metadata which includes the object entry and sending the copy of storage metadata and the copy of object metadata in the non-accelerator pool.

In one or more embodiments of the invention, the copy of storage metadata and the copy of object metadata are sent to a data node of a fault domain by the data processor. The data processor may further instruct the data node to distribute the copy of storage metadata and the copy of object metadata to other data nodes in the fault domain or to other data nodes in other fault domains. In this manner, a copy of the storage metadata is stored in multiple fault domains in the event of a storage metadata failure.

In one or more embodiments of the invention, the copy of storage metadata and object metadata is sent to multiple fault domains by the data processor. The data processor may send a copy of storage metadata and/or object metadata to one or more data nodes of each of the multiple fault domains. In this manner, a copy of the storage metadata and the object metadata is stored in multiple fault domains in the event of a storage metadata failure and/or an object metadata failure.

While FIG. 3A describes erasure coding and deduplicating the data, embodiments of the invention may be implemented where the data is only erasure coded and not deduplicated. In such embodiments, step 304 includes generating a storage metadata slice using non-deduplicated data chunks and parity chunks and step 306 includes distributing non-deduplicated data chunks and parity chunks

FIG. 3B shows a flowchart for performing an object replay in accordance with one or more embodiments of the invention. The method shown in FIG. 3B may be performed by, for example, a data processor (122, FIG. 1B). Other components of the system illustrated in FIG. 1B may perform the method of FIG. 3B without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

In step 320, an object replay request is obtained. The object replay request may be obtained from a host. The object replay request may specify an object and a point in time in which to replay the object.

In step 322, an object entry associated with the object replay request is identified from object metadata. In one or more embodiments of the invention, the data processor analyzes the object metadata to identify an object entry that includes both the object ID of the object specified in the object replay request and a timestamp of the point in time specified by the object replay request.

In step 324, data chunks associated with the object entry are identified. In one or more embodiments of the invention, the object entry includes chunk metadata that specifies the data chunks of the object at the point in time. The data processor may utilize the chunk metadata to obtain chunk identifiers (CIDs) (also referred to as fingerprints) associated with the data chunks.

In step 326, the identified data chunks are obtained from data nodes using storage metadata. In one or more embodiments of the invention, the data processor uses the obtained CIDs to identify one or more metadata slice entries of the storage metadata that specify the storage of the identified data chunks. The identified data chunks may be obtained by identifying the metadata slice entries, identifying the chunk metadata of the identified metadata slice entries, and obtaining the identified data chunks using storage information specified in the identified chunk metadata.

In step 328, object regeneration is performed using the obtained data chunks to generate an object associated with the object replay request. The object regeneration may include combining the obtained data chunks so that the data chunks collectively make up the object at the requested point in time.

In one or more embodiments of the invention, the object is provided to the host. The data processor, or another entity, may send the object to the host with confirmation that the object replay request has been serviced.

While the methods of FIG. 3A-3B are performed by data nodes of a data cluster with both an accelerator pool and a non-accelerator pool, embodiments of the invention may be implemented using a data cluster with only one tier of data nodes (e.g., a data cluster with only an accelerator pool or a data cluster with only a non-accelerator pool) without departing from the invention.

### Example

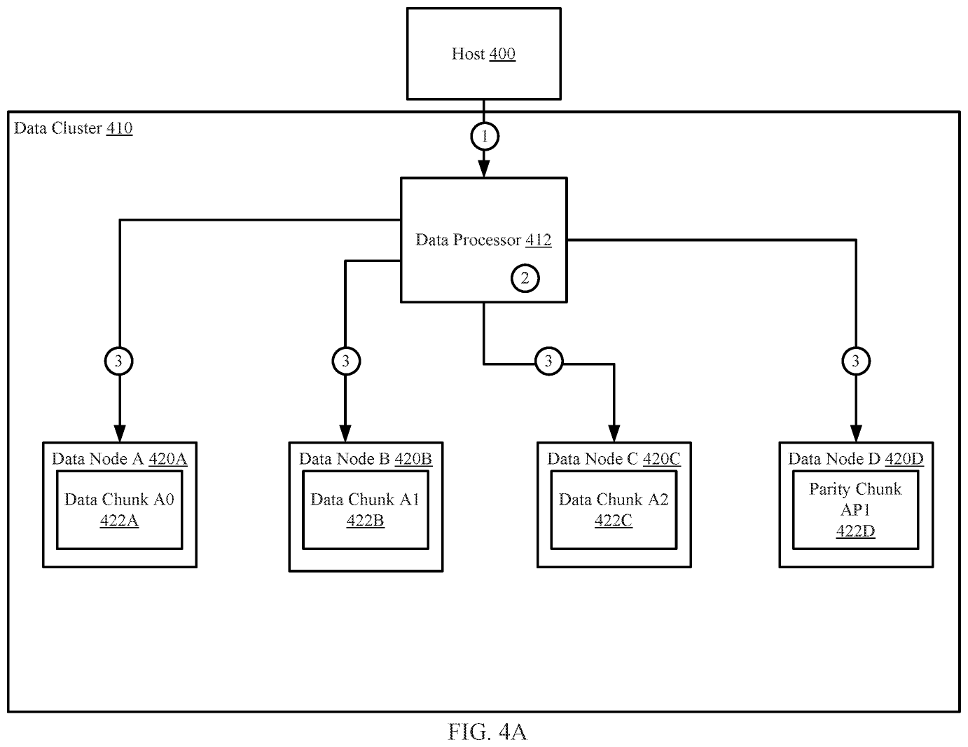

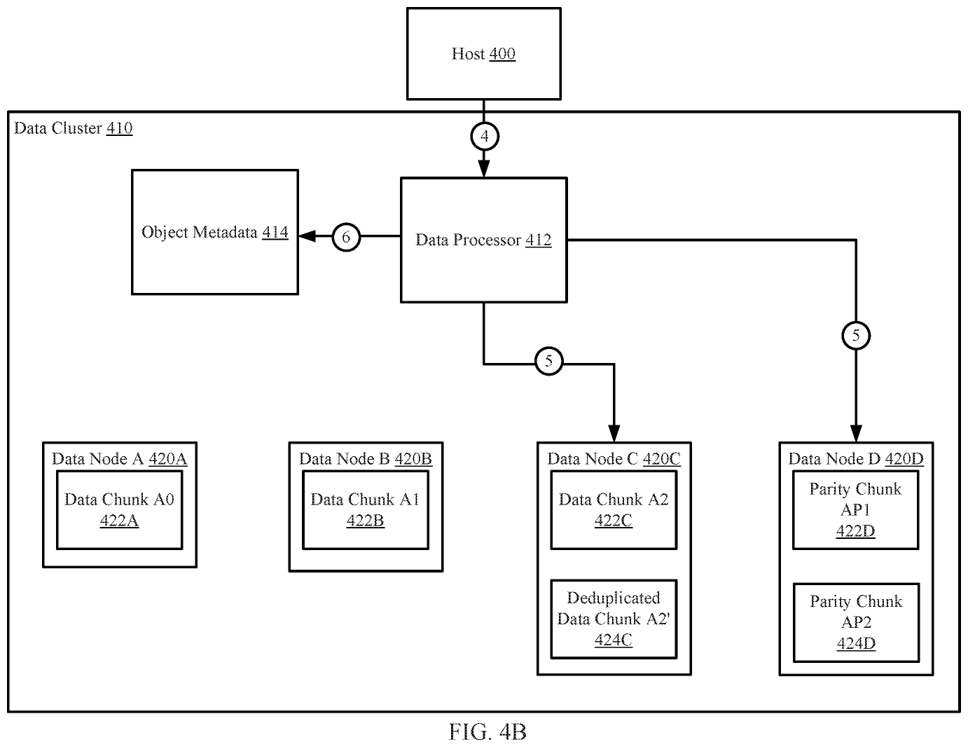

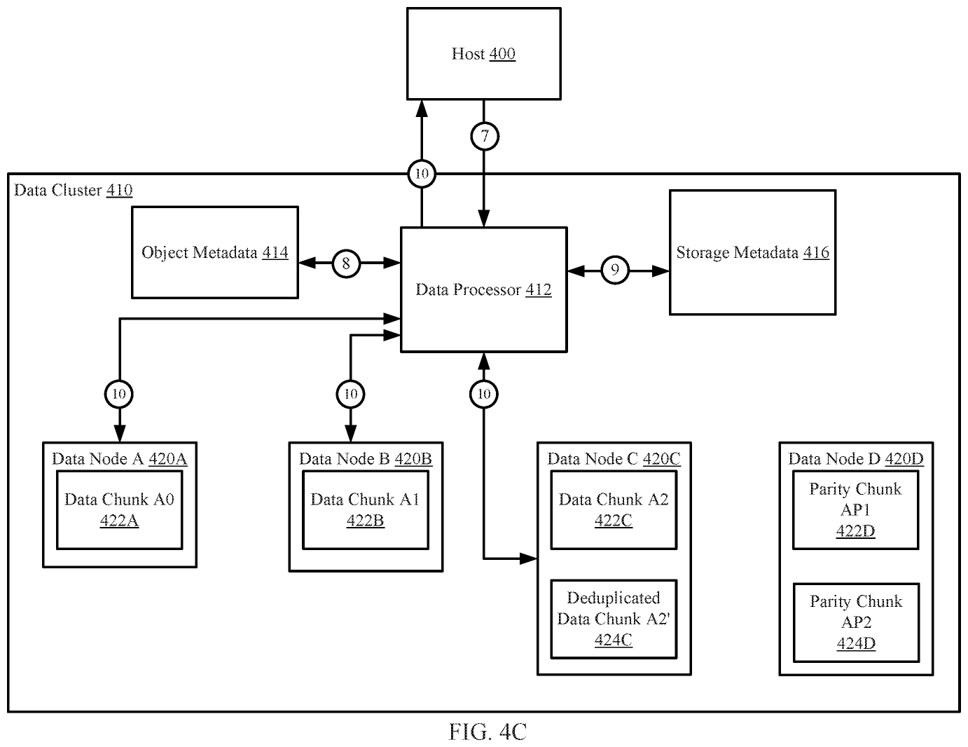

The following section describes an example. The example is not intended to limit the invention. The example is illustrated in FIGS. 4A-4C. Turning to the example, consider a scenario in which a data cluster obtains an object (e.g., a file) from a host. The host requests the object be stored in the data cluster using a 3:1 erasure coding procedure. FIG. 4A shows a diagram a system in accordance with one or more embodiments of the invention. The host (400) sends the request to a data processor (412).

The data processor (412) performs the method of FIG. 3A to store the obtained object. Specifically, the data processor performs an erasure coding procedure on the object [2]. In this example, assume that the erasure coding procedure includes implementing RAID-3. The result of the erasure coding procedure is a group of three data chunks A0, A1, and A2 (422A, 422B, 422C) and a parity chunk AP1 (422D). The data chunks and parity chunk may further go under a deduplication operation to obtain deduplicated data chunks. Because this object does not correspond to a previously-stored object, all three data chunks are deduplicated data chunks and, as such, all need to be stored in the non-accelerator pool.

The deduplicated data chunks and the parity chunk are stored across data nodes in the data cluster (410) [3]. Specifically, each of the three deduplicated data chunks and the parity chunk is stored in a unique fault domain. In this example, a first deduplicated data chunk is stored in data node A (420A) of a first fault domain, a second deduplicated data chunk is stored in data node B (420B) of a second fault domain, a third deduplicated data chunk is stored in data node C (420C) of a third fault domain, and the parity chunk is stored in data node D (420D) of a fourth fault domain.

In addition to storing the deduplicated data chunks and the parity chunks, the data processor generates a storage metadata slice entry in storage metadata (not shown) and an object entry in object metadata (not shown in FIG. 4A). A timestamp and a unique identifier of each deduplicated data chunk and parity chunk are stored in the storage metadata slice entry and in the object entry.

FIG. 4B shows a diagram of the example system. A second request is sent to the data processor (412) at a later point in time to store data associated with the object [4]. The data processor further performs an erasure coding procedure on the object to result in data chunks A0 (422A), A1 (422B), A2′ (424C), and parity chunk AP2 (424D). Data chunk A2′ (424C) is a modification of data chunk A2 (422C). The data processor (412) further performs a deduplication operation to obtain deduplicated data chunk A2′ (424C) by determining that data chunks A0 (422A) and A1 (422B) are already stored in the data cluster (410).

The data processor then stores the deduplicated data chunk A2′ (424C) in data node C (420C) based on storage metadata that specifies the storage of data chunk A2 (422C). Further, the data processor (412) stores parity chunk AP2 (424D) in data node D (420D) [5]. The data processor generates a second object entry that specifies a second timestamp and stores the object entry in the object metadata (414) [6]. At this point in time, two object entries are stored in the object metadata (412), wherein the first object entry specifies a first point in time and data chunks A0, A1, and A2. The second object entry specifies the second point in time and data chunks A0, A1, and A2′. While the object metadata specifies six data chunks, some of which are duplicates or each other, only one copy of each data chunk is stored in the non-accelerator pool.

FIG. 4C shows a diagram of the example system. At a later point in time, the host (400) sends an object replay request to obtain an object at the first point in time [7]. The data processor (412) uses the object replay request to identify the object entry in the object metadata (414) associated with the object at the first point in time [8]. After identifying the object entry, the data processor (412) identifies data chunks A0 (422A), A1 (422B), and A2 (422C) as the data chunks to be obtained to satisfy the object reply request. The data processor may analyze the storage metadata (416) to determine a storage location of the identified data chunks [9].

After identifying the storage locations of the data chunks, the data processor (412) communicates with the data nodes (420A, 420B, 420C) storing the data chunks (422A, 422B, 422C) to obtain the data chunks (422A, 422B, 422C). The obtained data chunks are then combined to regenerate the object at the requested point in time. The regenerated object is then sent to the host (400) [10]. In this manner, the host (400) obtains the object at the second point in time (i.e., the object associated with data chunks A0, A1, and A2′).

End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention improve the efficiency of storing data in a data cluster. The efficiency is improved by storing storage metadata that specifies where the data is stored and object metadata that specifies non-storage related metadata such as, for example, an object associated with the data. Embodiments of the invention include storing the data and tracking the storage location of the data to allow easier access to the data if a host requests to obtain the data.

Further, embodiments of the invention track a point in time for each instance (or version) of the object and track the data associated with the object associated with each instance. In this manner, a data cluster servicing a request to access an object at a specified point in time may utilize the object metadata and the storage metadata that track the points in time to obtain data associated with the request at the specified point in time. In this manner, the data in a data cluster may be easily accessed for any specified point in time.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing data, the method comprising:
obtaining data from a host;
applying an erasure coding procedure to the data to obtain a plurality of data chunks and at least one parity chunk;
deduplicating the plurality of data chunks to obtain a plurality of deduplicated data chunks;
generating storage metadata associated with the plurality of deduplicated data chunks and the at least one parity chunk;
generating an object entry associated with the plurality of deduplicated data chunks and the at least one parity chunk;
storing the storage metadata and the object entry in an accelerator pool;
storing, across a plurality of fault domains, the plurality of deduplicated data chunks and the at least one parity chunk; and
initiating metadata distribution on the storage metadata and the object entry across the plurality of fault domains.

2. The method of claim 1, further comprising:
obtaining an object replay request;
identifying the object entry based on the object replay request;
identifying the plurality of deduplicated data chunks and the at least one parity chunk using the object entry;
obtaining the plurality of deduplicated data chunks and the at least one parity chunk using the storage metadata; and
performing an object regeneration to generate an object associated with the object replay request.

3. The method of claim 2, wherein the object entry comprises a timestamp, an object identifier, and at least one chunk metadata, wherein the timestamp is associated with a point in time.

4. The method of claim 3, wherein the object replay request specifies the object identifier and the timestamp.

5. The method of claim 4, wherein identifying the object entry based on the object comprises making a determination that the object replay request specifies the object identifier and the timestamp.

6. The method of claim 1, wherein a non-accelerator pool comprises the plurality of fault domains.

7. The method of claim 1,
wherein storing the plurality of deduplicated data chunks and the at least one parity chunk comprises: storing a deduplicated data chunk of the plurality of deduplicated data chunks on a first data node in a fault domain of the plurality of fault domains,
wherein initiating metadata distribution on the storage metadata and object entry across the plurality of fault domains comprises: initiating storage of a copy of the storage metadata and a copy of the object entry on a second data node in the fault domain.

8. A non-transitory computer readable medium comprising computer readable program code, which when executed by a computer processor enables the computer processor to perform a method for managing data, the method comprising:
obtaining data from a host;
applying an erasure coding procedure to the data to obtain a plurality of data chunks and at least one parity chunk;
deduplicating the plurality of data chunks to obtain a plurality of deduplicated data chunks;
generating storage metadata associated with the plurality of deduplicated data chunks and the at least one parity chunk;
generating an object entry associated with the plurality of deduplicated data chunks and the at least one parity chunk;
storing the storage metadata and the object entry in an accelerator pool;
storing, across a plurality of fault domains, the plurality of deduplicated data chunks and the at least one parity chunk; and
initiating metadata distribution on the storage metadata and the object entry across the plurality of fault domains.

9. The non-transitory computer readable medium of claim 8, the method further comprising:
obtaining an object replay request;
identifying the object entry based on the object replay request;
identifying the plurality of deduplicated data chunks and the at least one parity chunk using the object entry;
obtaining the plurality of deduplicated data chunks and the at least one parity chunk using the storage metadata; and
performing an object regeneration to generate an object associated with the object replay request.

10. The non-transitory computer readable medium of claim 9, wherein the object entry comprises a timestamp, an object identifier, and at least one chunk metadata, wherein the timestamp is associated with a point in time.

11. The non-transitory computer readable medium of claim 10, wherein the object replay request specifies the object identifier and the timestamp.

12. The non-transitory computer readable medium of claim 11, wherein identifying the object entry based on the object comprises making a determination that the object replay request specifies the object identifier and the timestamp.

13. The non-transitory computer readable medium of claim 8, wherein a non-accelerator pool comprises the plurality of fault domains.

14. The non-transitory computer readable medium of claim 8,
wherein storing the plurality of deduplicated data chunks and the at least one parity chunk comprises: storing a deduplicated data chunk of the plurality of deduplicated data chunks on a first data node in a fault domain of the plurality of fault domains,
wherein initiating metadata distribution on the storage metadata and object entry across the plurality of fault domains comprises: initiating storage of a copy of the storage metadata and a copy of the object entry on a second data node in the fault domain.

15. A data cluster, comprising:
a host; and
an accelerator pool comprising a plurality of data nodes,
wherein a data node of the plurality of data nodes comprises a processor and memory comprising instructions, which when executed by the processor perform a method, the method comprising:
obtaining data from the host;
applying an erasure coding procedure to the data to obtain a plurality of data chunks and at least one parity chunk;
deduplicating the plurality of data chunks to obtain a plurality of deduplicated data chunks;
generating storage metadata associated with the plurality of deduplicated data chunks and the at least one parity chunk;
generating an object entry associated with the plurality of deduplicated data chunks and the at least one parity chunk;
storing the storage metadata and the object entry in the accelerator pool;
storing, across a plurality of fault domains, the plurality of deduplicated data chunks and the at least one parity chunk; and
initiating metadata distribution on the storage metadata and the object entry across the plurality of fault domains.

16. The data cluster of claim 15, wherein the node is further programmed to:
obtaining an object replay request;
identifying the object entry based on the object replay request;
identifying the plurality of deduplicated data chunks and the at least one parity chunk using the object entry;
obtaining the plurality of deduplicated data chunks and the at least one parity chunk using the storage metadata; and
performing an object regeneration to generate an object associated with the object replay request.

17. The data cluster of claim 16, wherein the object entry comprises a timestamp, an object identifier, and at least one chunk metadata, wherein the timestamp is associated with a point in time.

18. The data cluster of claim 17, wherein the object replay request specifies the object identifier and the timestamp.

19. The data cluster of claim 18, wherein identifying the object entry based on the object comprises making a determination that the object replay request specifies the object identifier and the timestamp.

20. The data cluster of claim 15,
wherein storing the plurality of deduplicated data chunks and the at least one parity chunk comprises: storing a deduplicated data chunk of the plurality of deduplicated data chunks on a first data node in a fault domain of the plurality of fault domains,
wherein initiating metadata distribution on the storage metadata and object entry across the plurality of fault domains comprises: initiating storage of a copy of the storage metadata and a copy of the object entry on a second data node in the fault domain.
